(19) United States
(12) Patent Application Publication
(10) Pub. No.: US 2014/0130888 A1
(43) Pub. Date: May 15, 2014

(54) CONDENSATE MANAGEMENT SYSTEM AND METHODS

(71) Applicant: Plexaire LLC, Wayne, NJ (US)

(72) Inventors: Stewart Kaiser, Boca Raton, FL (US); William G. Williams, Tyler, TX (US)

(73) Assignee: Plexaire LLC, Wayne, NJ (US)

(21) Appl. No.: 14/079,451

(22) Filed: Nov. 13, 2013

Related U.S. Application Data
(60) Provisional application No. 61/725,828, filed on Nov. 13, 2012.
(60) Provisional application No. 61/752,364, filed on Jan. 14, 2013.
(60) Provisional application No. 61/792,640, filed on Mar. 15, 2013.

(51) Int. Cl. F24F 13/22; B08B 3/04

(52) U.S. Cl. CPC F24F 13/222; B08B 3/04
USPC 137/15.01; 137/246.22

(57) ABSTRACT

An intelligent condensate management system for purging and cleaning an air conditioning condensate drainage system, the intelligent condensate management system comprises a housing, the housing having an inlet and an outlet; a primary condensate flow line providing a flow path between the housing inlet and outlet, the primary condensate flow line having a check valve; a flush line providing a flow path between the housing inlet and outlet parallel to the primary condensate flow line, the flush line having a pump, wherein an inlet to the flush line is connected to a lower portion of the housing inlet; a logic panel for actuating the pump between a standby mode and a flushing mode; wherein the check valve is configured to allow flow from the housing inlet to the housing outlet; wherein actuating the pump to a flushing mode causes the check valve to close. Also described are methods to flush a condensate drain system.

### CROSS-REFERENCE TO RELATED APPLICATIONS

This application claims priority to U.S. Provisional Application Ser. No. 61/725,828, filed on Nov. 13, 2012, U.S. Provisional Application Ser. No. 61/752,364, filed on Jan. 14, 2013, and U.S. Provisional Application Ser. No. 61/792,640, filed on Mar. 15, 2013, the disclosures of which are incorporated herein by reference in their entireties.

### TECHNICAL FIELD

The present invention relates generally to condensate management systems and methods and, more particularly, to systems and methods for protecting an air conditioning system from condensate flooding or overflow.

### BACKGROUND

A common and well documented problem within the heating, ventilation, and air conditioning industry is the growth of a bacterial slime substance known as zooglea. As well known to one of ordinary skill in the art, zooglea may grow on walls of an air conditioning system's condensate drain pipes and narrow the drainage flowpath. Similarly, other debris or contaminants such as rust particles, hair, dirt, and other items may also build up in the condensate drain pipes. In time, zooglea or the other debris and contaminants can partially or fully obstruct condensate flow from the condensate drain pipes and cause condensate backup or flooding of the air conditioning system. These obstructions may occur in the air conditioning unit or downstream in the condensate drain pipes. Many solutions have been attempted, such as chemical treatments, manual cleanings, and drain line purging systems, but none have had great effect clearing obstructions along the entire condensate drain system flow path.

For example, clogs which form within the drain pan or upstream of a purging system are particularly difficult to remove using conventional drain line purging systems. Conventional drain line purging systems only push obstructions downstream of the purging system by creating a positive pressure. However, these conventional purging systems did little or nothing for clogs upstream of the purging system.

### SUMMARY

According to an embodiment, an intelligent condensate management system is disclosed for purging and cleaning an air conditioning condensate drainage system, the intelligent condensate management system comprises a housing, the housing having an inlet and an outlet; a primary condensate flow line providing a flow path between the housing inlet and outlet, the primary condensate flow line having a check valve; a flush line providing a flow path between the housing inlet and outlet parallel to the primary condensate flow line, the flush line having a pump, wherein an inlet to the flush line is connected to a lower portion of the housing inlet; a logic panel for actuating the pump between a standby mode and a flushing mode; wherein the check valve is configured to allow flow from the housing inlet to the housing outlet; wherein actuating the pump to a flushing mode causes the check valve to close.

According to another embodiment, a method for purging a condensate drainage system for an air conditioning system is disclosed, wherein the air conditioning system comprises a compressor, an evaporator, a condenser, and a fan, the method comprising providing the condensate drainage system with a check valve in a primary condensate flow line and a pump in a flush line; wherein the flush line and primary condensate flow line are parallel to each other and an inlet to the flush line is connected to a lower portion of the primary condensate flow line; providing a check valve in the primary condensate flow line; providing a pump in the flush line; alerting a logic panel to a condition for flushing the condensate drainage system; energizing the pump, wherein the pressure differential caused by the pump causes the check valve to close; de-energizing the pump after a predetermined period of time; determining whether the condition for flushing the condensate drainage system is resolved.

Further aspects, objectives, and advantages, as well as the structure and function of embodiments, will become apparent from a consideration of the description, drawings, and examples.

### BRIEF DESCRIPTION OF THE DRAWINGS

The features and advantages of the embodiments will be apparent from the following drawings wherein like reference numbers generally indicate identical, functionally similar, and/or structurally similar elements.

FIG. 1 is a process flow diagram according to an embodiment;

FIG. 2 is a process flow diagram according to an embodiment;

FIG. 3 is a process flow diagram according to an embodiment;

FIG. 4 is a process flow diagram according to an embodiment;

FIG. 5 is a negative pressure air handler and drainage system having an intelligent condensate management system according to an embodiment;

FIG. 6 is a positive pressure air handler and drainage system having an intelligent condensate management system according to an embodiment;

FIG. 7 is an intelligent condensate management system according to an embodiment;

FIG. 8 is a process flow diagram of an intelligent condensate management system according to an embodiment;

FIG. 9 is a power circuit according to an embodiment;

FIG. 10 shows a condensate drain location and a secondary drain location for a heating, ventilation, and air conditioning system for use in an embodiment;

FIG. 11 is a safety switch for use in an embodiment;

FIG. 12 is a logic flow chart of a logic panel according to an embodiment;

FIG. 13 is a logic flow chart of a logic panel according to an embodiment;

FIG. 14 is a logic flow chart of a logic panel according to an embodiment;

FIG. 15 is a wiring diagram of the intelligent condensate management system integrated into a heating, ventilation, and air conditioning system according to an embodiment;

FIG. 16 is a wiring diagram of the intelligent condensate management system integrated into a heating, ventilation, and air conditioning system including a water sensor according to an embodiment; and

FIG. 17 is a process flow diagram according to an embodiment.

### DETAILED DESCRIPTION

Embodiments of the invention are discussed in detail below. In describing embodiments, specific terminology is employed for the sake of clarity. However, the invention is not intended to be limited to the specific terminology so selected. A person skilled in the relevant art will recognize that other equivalent parts can be employed and other methods developed without departing from the spirit and scope of the invention.

### Air Conditioning and Drainage System Configuration

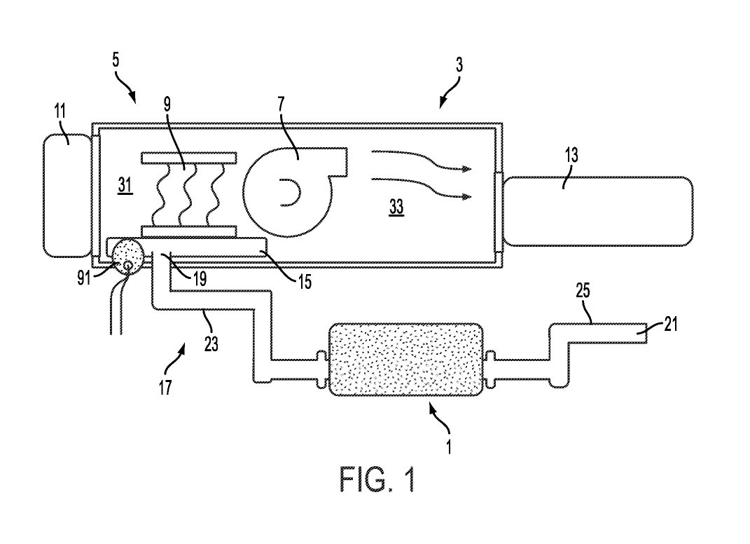

Referring now to FIGS. 1-4, there are shown various configurations of an air conditioning system and condensate drainage system having an intelligent management condensate system (ICM) 1. As known to one of ordinary skill in the art, the air conditioning unit 3 generally comprises an air handler 5 having a fan blower 7, evaporator coil 9, compressor (not shown), and condenser (not shown) therein. The fan blower 7 urges air from an air return 11 of the air handler 5, across the evaporator coil 9, and to an air supply 13 of the air handler 5. As air is drawn across the evaporator coil 9, condensate is formed thereat and flows into a condensate drain pan 15. In turn, condensate collected in the condensate drain pan 15 flows out of the air handler 5 and into a condensate drainage system 17 having the ICM 1. According to an embodiment, an inlet 19 of the condensate drainage system 17 is generally at an elevation above an outlet 21 of the condensate drainage system 17 in order to allow condensate to gravity drain away from the drain pan 15. Hereinafter, the portion of the condensate drainage system 17 between the drainage system inlet 19 and the ICM 1 is referred to as the upstream drainage portion 23; the portion of the condensate drainage system between the drainage system outlet 21 and the ICM 1 is referred to as the downstream drainage portion 25.

Referring now to FIGS. 1-3, a negative pressure-type air conditioning unit configuration is illustrated. In general, the air conditioning units 3 of these illustrated embodiments use the fan blower 7 to create a vacuum at the fan blower suction 31 to pull air across the evaporator coil 9. As a result, the drainage system 17 may be subject to the vacuum or negative pressure from the fan blower 7.

Referring now to FIG. 1, an embodiment of a drainage system 17 is illustrated. According to this embodiment, the ICM 1 may be installed at an elevation below the elevation of the drainage system inlet 19 and the drainage system outlet 21. In effect, the relative elevations of the upstream drainage portion 23, downstream drainage portion 25, and ICM 1 form a condensate trap wherein condensate is trapped at the elevation of the ICM 1, thus submerging the ICM 1 in condensate. As discussed below, the ICM 1 may operate advantageously when submerged in condensate.

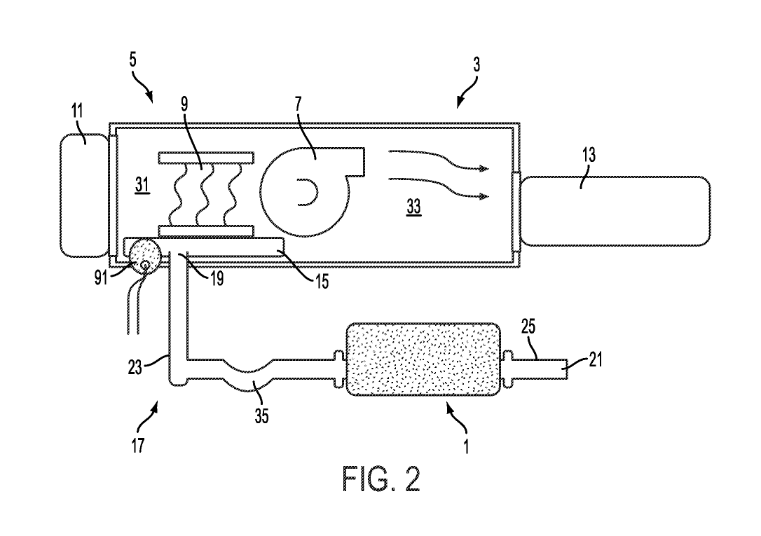

Referring now to FIG. 2, an embodiment of a drainage system 17 is illustrated. According to this embodiment, the ICM 1 may be installed at an elevation below the elevation of the drainage system inlet 19 and approximately at or above the elevation of the drainage system outlet 21. The upstream drainage portion 23 may include an upstream trap 35. For example, the upstream trap 35 may be a p-trap or other type of trap, as known to one of ordinary skill in the art. The upstream trap 35 may trap condensate between the upstream drainage portion 23 and the drainage system inlet 19. In effect, the upstream trap 35 isolates the ICM 1 from the negative pressure at the drainage system inlet 19 from the fan blower 7. As discussed below, the ICM 1 may operate advantageously when isolated from the negative pressure from the fan blower 7.

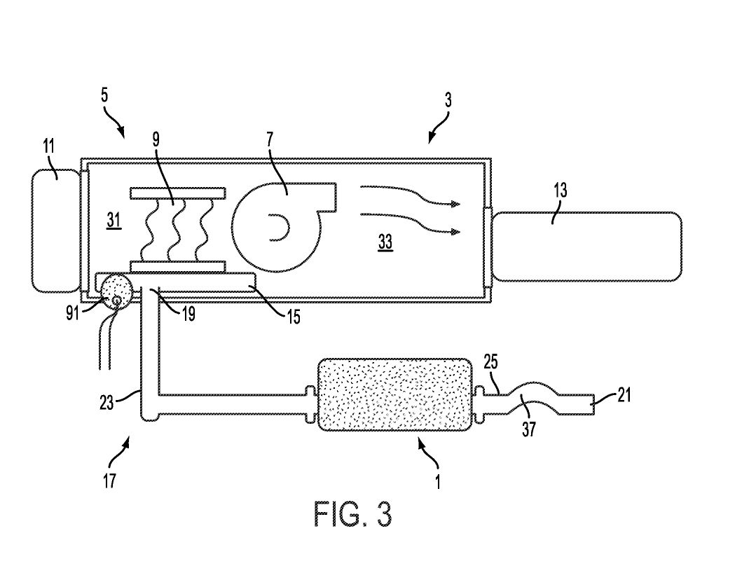

Referring now to FIG. 3, an embodiment of a drainage system 17 is illustrated. According to this embodiment, the ICM 1 may be installed at an elevation below the elevation of the drainage system inlet 19 and approximately at or above the elevation of the drainage system outlet 21. The downstream drainage portion 25 may include a downstream trap 37. For example, the downstream trap 37 may be an inverted p-trap or other type of trap, as known to one of ordinary skill in the art. In effect, the downstream trap 37 may trap condensate between the downstream trap 37 and the drainage system inlet 19 wherein condensate may be trapped at the elevation of the ICM 1 thus submerging the ICM 1 in condensate. As discussed below, the ICM 1 may operate advantageously when submerged in condensate.

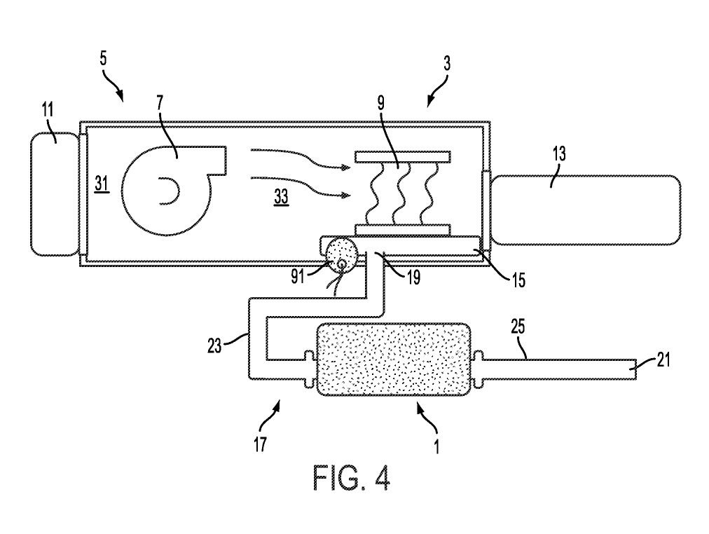

Referring now to FIG. 4, in an alternative embodiment, a positive pressure-type air conditioning unit configuration is illustrated. In particular, the air conditioning unit 3 uses the fan blower 7 to create a positive pressure at the fan blower discharge 33 to push air across the evaporator coil 9. As a result, the drainage system 17 may be subject to the positive pressure from the fan blower 7.

Still referring to FIG. 4, according to this embodiment, the ICM 1 may be installed at an elevation below the elevation of the drainage system inlet 19 and approximately at or above the elevation of the drainage system outlet 21. Alternatively, depending on the positive pressure from the fan blower 7, the ICM 1 may be installed below the elevation of the drainage system outlet 21 or above the elevation of the drainage system inlet 19. The positive pressure from the fan blower 7 pushes condensate through the drainage system 17. According to an embodiment, no traps are installed on the upstream drainage portion 23 or the downstream drainage portion 25. However, according to another embodiment illustrated in FIG. 4, an upstream trap 35 and/or a downstream trap 37, as described above and discussed below, may cause the ICM 1 to operate advantageously.

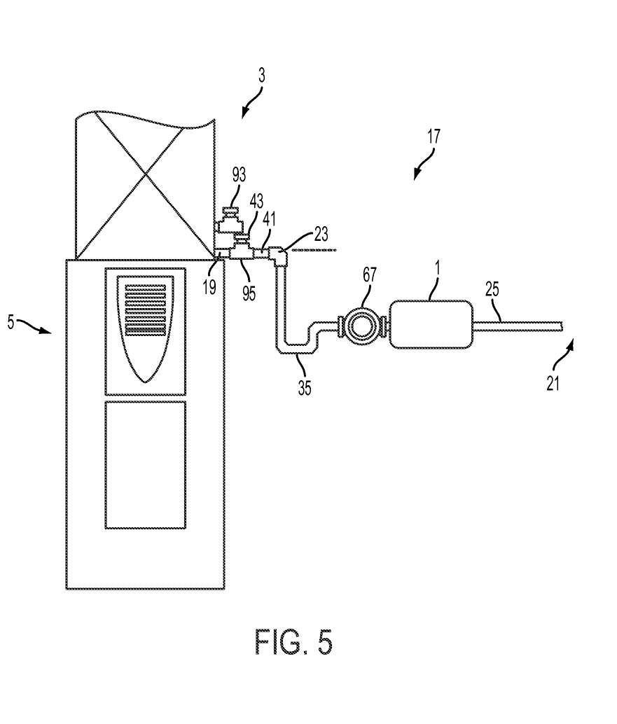

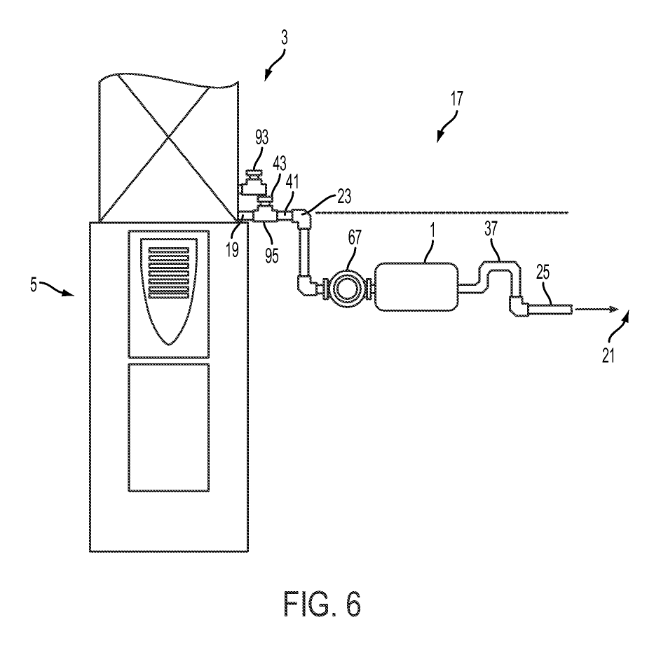

Referring now to FIGS. 5 and 6, embodiments of the air conditioning unit 3 and drainage system 17 are illustrated, for example, as installed in a home. Specifically referring now to FIG. 5, a negative pressure-type air conditioning unit, such as, for example, a down flow furnace, configuration is illustrated in combination with a drainage system 17, such as, for example, the drainage system illustrated in FIG. 2. By example, according to an embodiment, the upstream trap 35 has preferably at least a 4-inch vertical drop from the drainage system inlet 19 at the air handler 5 to the elevation of the ICM 1. However, other vertical drops, either greater than or less than the 4-inch vertical drop, are contemplated by embodiments. According to an embodiment, no downstream traps are included in the downstream drainage portion 25 such that air may vent freely to the drainage system outlet 21. Additionally, the upstream drainage portion 23 may be provided with a clear or transparent upstream drainage portion 41 and an upstream clean out cap 43 for observing condensate flow or obstructions and cleaning the upstream drainage portion, respectively.

Referring now to FIG. 6, a positive pressure-type air conditioning unit, such as, for example, an up flow furnace, configuration is illustrated in combination with a drainage system 17, such as, for example, the drainage system illustrated in FIG. 4. However, according to the embodiment illustrated in FIG. 6, a downstream trap 37, such as an inverted p-trap, is provided at the downstream drainage portion 25. By example, according to an embodiment, the downstream trap 37 has preferably at least a 2-inch vertical drop from the drainage system inlet 19 at the air handler 5 to the upper elevation of the downstream trap 37. However, other vertical drops, either greater than or less than the 2-inch vertical drop, are contemplated by embodiments. According to an embodiment, no traps are included downstream of the downstream trap 37 such that air may vent freely to the drainage system outlet 21.

### Pump and Valve Configuration

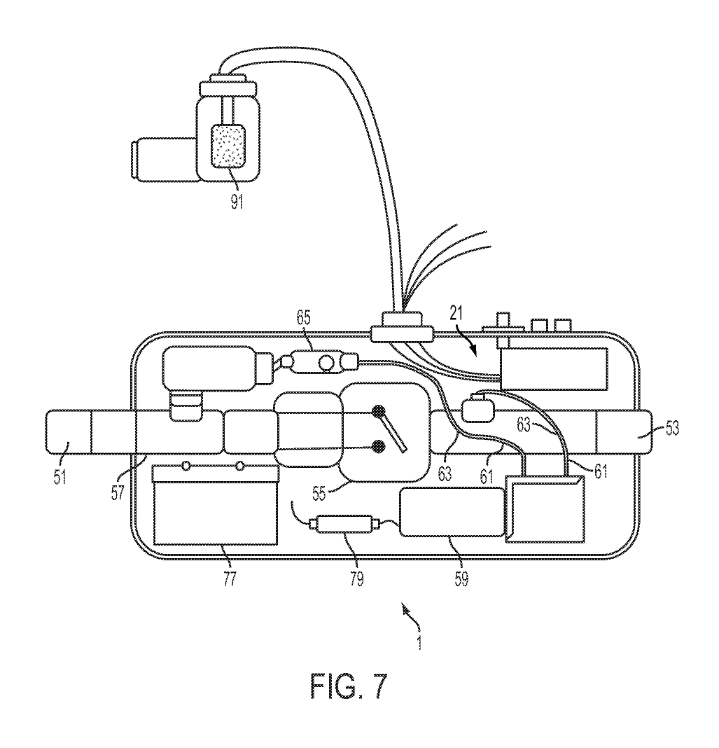

Referring now to FIG. 7, an embodiment of the ICM 1 is illustrated. The ICM 1 generally comprises an ICM housing 49 having an ICM inlet 51, an ICM outlet 53, a check valve 55 in an ICM primary condensate flow line 57, and a pump 59 in an ICM flush line 61, wherein the ICM primary condensate flow line 57 and the ICM flush line 61 are in parallel with respect to each other and share the common ICM inlet 51 and ICM outlet 53. The ICM inlet 51 connects to the upstream drainage portion 23. The ICM outlet 53 connects to the downstream drainage portion 25. According to other embodiments, the ICM flush line 61 may connect to the upstream drainage portion 23 and/or the downstream drainage portion 25 while maintaining a parallel relationship with the ICM primary condensate flow line 57.

The check valve 55 is configured to normally allow condensate to flow from the ICM inlet 51 to the ICM outlet 53. According to some embodiments, the check valve 55 may be a swing or flapper-type check valve. For example, during normal condensate draining conditions, the flow of condensate from the ICM inlet 51 to the ICM outlet 53 urges the check valve 55 to the open position to allow the condensate to flow to a drainage location. Upon a backflow condition where condensate begins flowing from the ICM outlet 53 to the ICM inlet 51, the backflow of condensate urges the check valve to a closed position thereby protecting condensate from flooding into the drain pan 15 and air handler 5. Thus, the check valve 55 may protect the air conditioning unit 3 from damage due to condensate backflow. Because the check valve 55 is actuated from the hydraulic process flow of the condensate, no externally powered actuator is required to actuate the check valve 55. Thus, even upon loss of power to the air conditioning unit 1 and associated equipment, protection from backflow from the drainage system 17 is maintained. According to other embodiments, other check valves may be used such as, for example, a ball check valve, a diaphragm check valve, a stop-check valve, an in-line check valve, or other check valves as known to one of ordinary skill in the art.

According to an embodiment, the angle of the flapper of the flapper-type check valve may be adjusted in order to adjust the response time of the check valve during back flow conditions. For example, a substantially horizontal flapper may be adjusted to a ½ inch pitch in order to increase the response time of the check valve during back flow conditions to 1.5 seconds to 3.5 seconds to fully close the check valve.

The pump 59 may be a water, air, or hybrid water/air pump. According to other embodiments, other types of pumps may be used such as, for example, a diaphragm pump or other types of pumps as known to one of ordinary skill in the art. According to an embodiment, the pump 59 may be capable of pumping air, water, chemicals and/or gases, liquids, and debris. The pump 59 in the ICM flush line 61 may be connected to the ICM inlet 51 and ICM outlet 53 with flexible hoses 63 thereby allowing compact assembly of the ICM 1. Alternatively, the pump 59 may be connected with rigid piping or tubing to provide structural integrity to the assembly of the ICM 1. Additionally, the inlet of the pump 59 may be provided with a check valve 61 to prevent back flow through the pump 59. For example, the check valve 61 may be a ball check valve, a diaphragm check valve, a stop-check valve, an in-line check valve, or other check valves as known to one of ordinary skill in the art. Alternatively, according to another embodiment, no check valve may be provided at the inlet of the pump 59.

According to some embodiments, as explained above, the check valve 55 may be isolated from negative pressure from the fan blower 7 in a negative pressure-type air conditioning unit in order to avoid negative pressure from closing the check valve 55. In a flow profile of the upstream drainage portion 23 having a condensate level and an air gap thereabove, negative pressure may urge the check valve 55 to the closed position even while condensate is flowing through the drainage system 17. Isolating the check valve 55 from the negative pressure at the system inlet 19 with, for example, the upstream trap 35, prevents such negative pressure from affecting operation of the check valve 55.

Similarly, the check valve 55 may be isolated from the positive pressure from a positive pressure-type air conditioning unit. In a flow profile of the upstream drainage portion 23 having a condensate level and an air gap thereabove, positive pressure may urge the check valve 55 to the open position even while, for example, condensate is back flowing through the check valve 55. Isolating the check valve 55 from the positive pressure at the system inlet 19 with, for example, the upstream trap 35, prevents such positive pressure from affecting operation of the check valve 55.

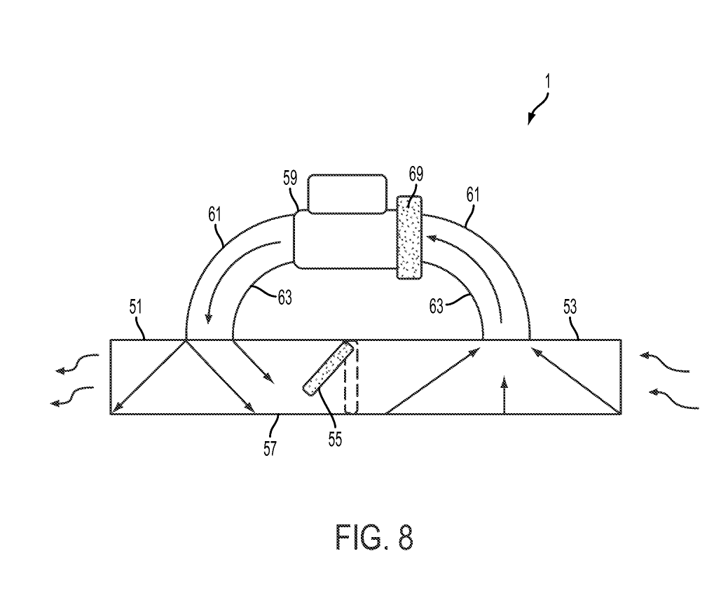

Referring again to FIGS. 4 and 5, a filter 67 may be installed in the upstream drainage portion 23 of the drainage system 17 to prohibit debris entering and damaging the ICM 1 and damaging the components contained therein, such as, for example, pump 59. The filter 67 may be a self-contained and installed in-line filter to collect debris in the drainage system 17. Additionally, the filter 67 may filter the condensate of metallic debris which could collect in the drain pan 15 of the air handler 5. Alternatively, according to another embodiment, no filter may be provided at upstream drainage portion 23. Referring now to FIG. 8, a filter 69 may be installed at the pump 59 inlet thereby allowing debris to flow freely through the ICM primary condensate flow line 57 during normal condensate draining conditions while the ICM 1 is in a standby mode with the pump in the OFF position.

Referring now to FIG. 8, the fluid flow and/or pressure profile of the ICM 1 is shown. As explained above, during normal condensate draining conditions, the pump 59 is in an OFF configuration or standby mode and condensate generally flows through the ICM primary condensate flow line 57 from the ICM inlet 51 to the ICM outlet 53. During other conditions, such as a flooding condition or during a maintenance/cleaning operation the pump 59 switches to an ON configuration or flushing mode and pumps condensate from the ICM inlet 51 to the ICM outlet 53 through the ICM flush line 61. As a result the pump 59 creates a negative pressure or vacuum at the ICM inlet 51 and a positive pressure at the ICM outlet 53. Similar to the backflow condition explained above, the pump 59 creates a pressure differential across the check valve 55 to cause the check valve to move to the closed position. In other words, the pump 59 causes the pressure profile across the check valve 55 to mimic that of a backflow condition and causes the check valve 55 to move to the closed position. In effect, the pump 59 and check valve 55 are actuated in series. For example, electricity is applied, as explained below, to energize the pump 59 and the pump 59, in turn, creates a differential pressure across the check valve 55 to actuate the check valve 55 to a closed position. Advantageously, the hydraulic actuation of the check valve 55 with the pressure profile created by the pump 59 minimizes the power required by the ICM 1 to flush the drainage system 17.

The negative pressure created by the pump 59 in the drain pan 15 and upstream drainage portion 23 of the drainage system 17, causes obstructions to become dislodged and be pumped through the drainage system 17. In the downstream drainage portion 25 of the drainage system 17, the positive pressure created by the pump 59 will force obstructions to become dislodged and be pumped through the drainage system 17 by forcing condensate against the obstruction. Therefore, actuation of pump 59 to an ON configuration applies negative and positive pressure to the upstream drainage portion 23 and downstream drainage portion 25, respectively, to clear the entire drainage system 17 of obstructions. When the pump 59 is de-energized or actuated to the OFF or standby mode, the check valve 55 will return to normal operation. Advantageously, any backflow of liquid immediately after the pump 59 is de-energized will be contained in the downstream drainage portion 25 by closure of the check valve 55.

According to other embodiments, a person of skill in the art will recognize that although condensate is referred to in the exemplary embodiments, any liquid may be in the system. Additionally, one of ordinary skill in the art will recognize from the present disclosure, that the pump 59 may pump air or other gases to obtain the described pressure differential across check valve 55. However, due to the generally incompressible nature of liquids, submerging the ICM 1 in condensate or liquid, including the pump 59 and check valve 55, may achieve a faster check valve 55 response time when the pump 59 is actuated to the ON position or flushing mode. Thus, the ICM 1 protects the air conditioning unit 3 from backflow conditions and flushes the entire drainage system 17 through use of the single check valve 55, as explained above. Integrating these functions into a single check valve allows for fewer parts, lighter weight, and simpler installation of the ICM 1 over the prior art installations.

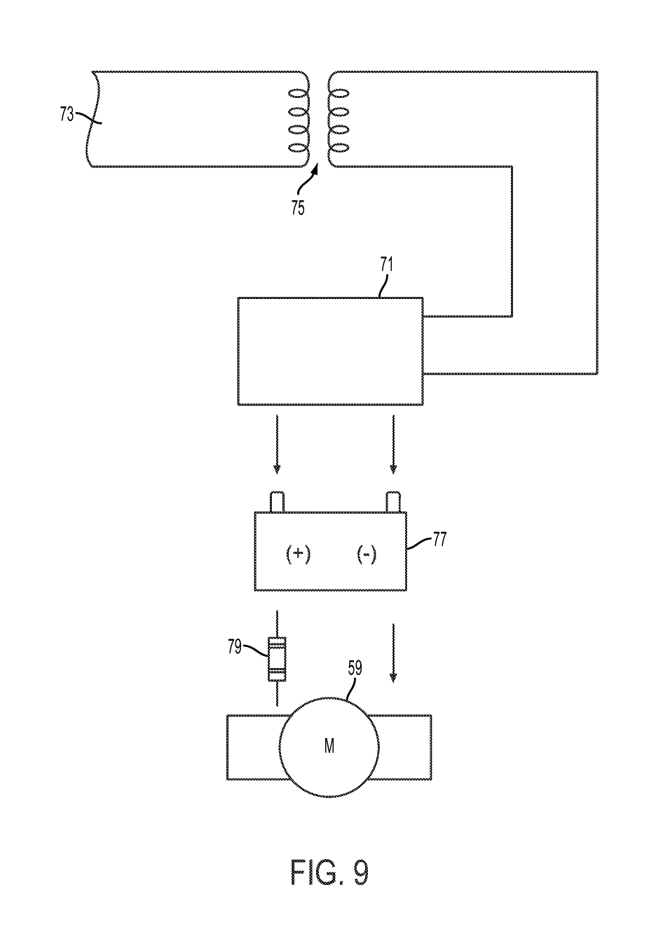

The pump 59, and, therefore the ICM 1, is actuated or energized through an ICM logic panel 71 and associated electrical components. Referring now to FIG. 9, the ICM logic panel 71 and power circuit are illustrated. According to an embodiment, 110-volt alternating current may be provided by a power source 73 such as by, for example, a standard wall outlet. A transformer 75 steps down the power source 73 current to 24-volt alternating current. For example, the transformer 75 may be located in the furnace or air handler. The 24-volt alternating current flows to the ICM logic panel 71 where the alternating current is converted to direct current. According to an embodiment, the ICM logic panel 71 may contain, for example, a rectifier (not shown) to convert the alternating current to direct current. The ICM logic panel 71 uses the direct current to charge a battery 77 to operate the pump 59 of the ICM 1. For example, the ICM logic panel 71 may float or trickle charge the battery 77 with relatively low current. In turn, the float charged battery 77 may provide a large amount of direct current for use by the pump 59. For example, the pump 59 may operate on 10.5-15 direct current voltage with an amperage of 1.5-5 amps under large pumping loads. Further, a fuse 79 may be provided to protect the battery 77 and the ICM logic panel 71 from electrical shorts.

Referring again to FIG. 7, the ICM logic panel 71, battery 77 and transformer 75 may be contained within the ICM 1. The logic panel 71 may actuate or energize the pump 59 according to 1) a float switch 91, 2) a preprogrammed maintenance schedule, 3) a user actuated switch 14, and/or 5) a water sensor (not shown).

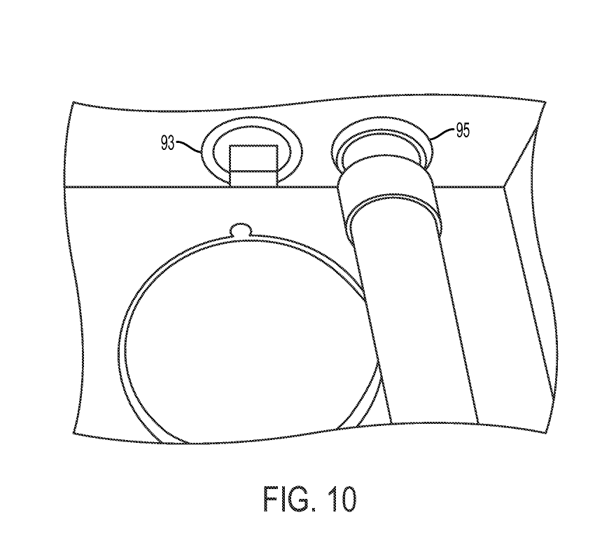

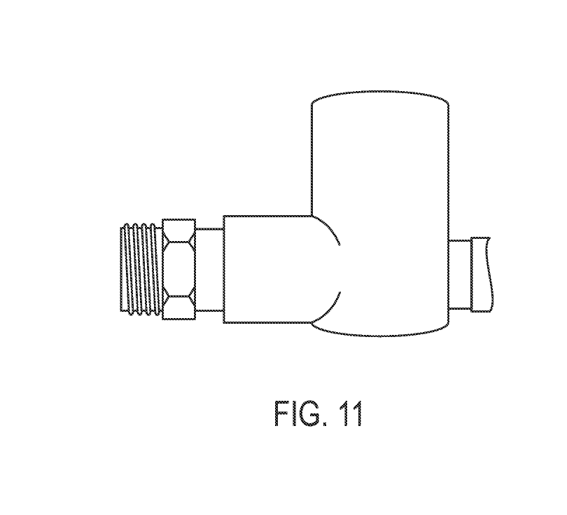

Referring now to FIGS. 10 and 11, according to an embodiment, the float switch 91 may be located in the drain pan 15 of the air handler 5 and installed through a secondary drain port 93 of the air handler 5. The float switch 91 activates or alerts the ICM logic panel 71 to flush or purge the drainage system 17 when condensate in the drain pan 15 exceeds a predetermined level. Thus, an obstruction or clog at any point along the drainage system 17 will alert the ICM logic panel 71. According to another embodiment, the float switch 91 may be located in a primary drain port 95 of the air handler 5 if, for example, a secondary drain port is unavailable.

Similarly, water sensors (not shown) may be provided in the air handler 5, drain pan 15, or external to the air conditioning unit 3 to alert the ICM logic panel 71 of the presence of water or liquid.

### Operating Sequences of the ICM

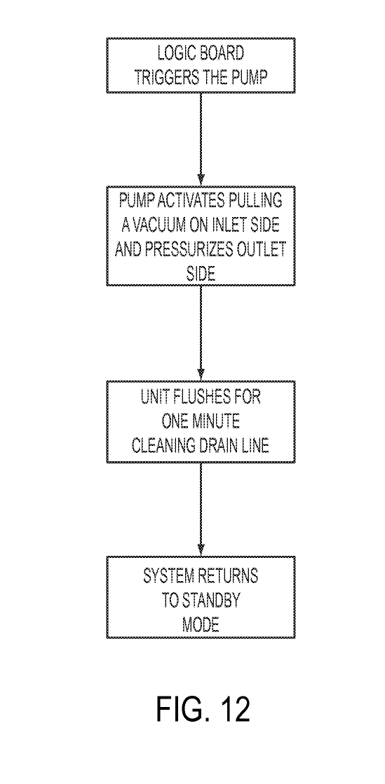

Referring now to FIGS. 12-14, various operating sequences according to embodiments are illustrated. Referring now to FIG. 12, the operating sequence of the ICM 1 is illustrated according to a preprogrammed or predetermined maintenance schedule. For example, the logic panel 71 may be programmed to activate the ICM 1 to flush the drainage system 17 every 48 hours. It is foreseen that the logic panel 71 may be programmed to activate the ICM 1 to flush the drainage system 17 periodically at regular or irregular time intervals. According to the predetermined time interval, the logic board 71 activates the pump 59 to the ON position or flushing mode. As explained above, the pump 59 creates a negative pressure or vacuum at the ICM inlet 51 and a positive pressure at the ICM outlet 53 thereby flushing the drainage system 17. The ICM 1 continues flushing the drainage system 17 for approximately one minute, or any other predetermined time period, to clean the drainage system 17 of zooglea, buildup, or other debris while the air conditioning unit 3 operates normally. Thereafter, the logic panel 71 deactivates the pump 59 and returns it to the standby mode.

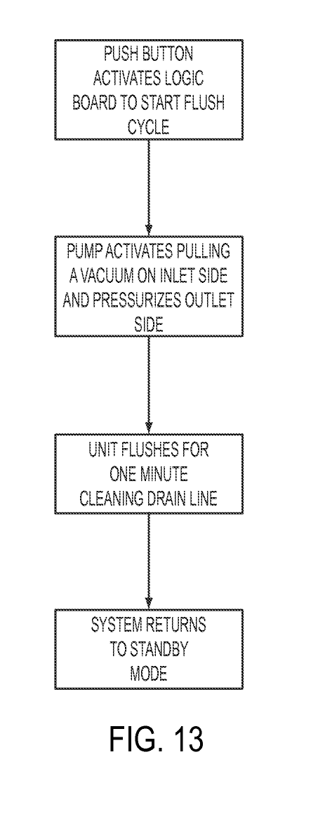

Referring now to FIG. 13, the operating sequence of the ICM 1 is illustrated according to a user activated switch or push button activated flush.

Upon a user manually pushing a button on the ICM 1 or remotely activating the ICM 1, the logic panel 71 activates the pump 59 to the ON position or flushing mode. As explained above, the pump 59 creates a negative pressure or vacuum at the ICM inlet 51 and a positive pressure at the ICM outlet 53 thereby flushing the drainage system 17. The ICM 1 continues flushing the drainage system 17 for approximately one minute, or any other predetermined time period, to clean the drainage system 17 of zooglea, buildup, or other debris while the air conditioning unit 3 operates normally. Thereafter, the logic panel 71 deactivates the pump 59 and returns it to the standby mode.

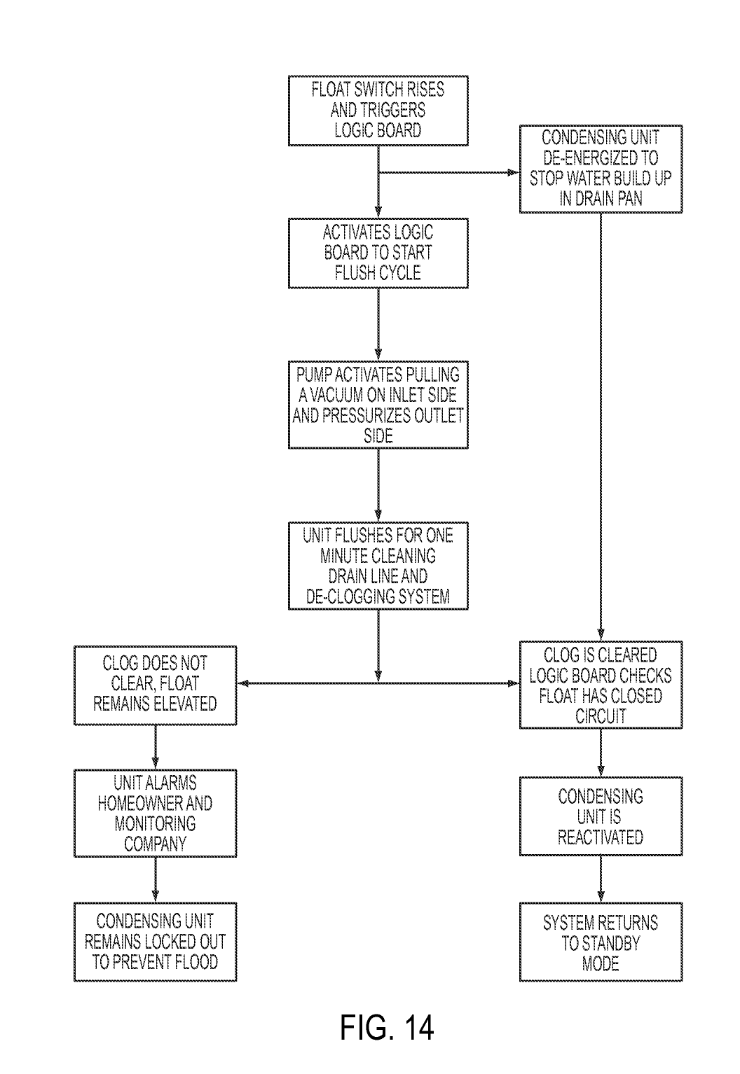

Referring now to FIG. 14, the operating sequence of the ICM 1 is illustrated according to being activated by the float switch 91, or, alternatively, the water sensor. When the float switch 91 is elevated by a high condensate level in the drain pan 15 or other location, the logic panel 71 is alerted to the high condensate level. The logic panel 71 de-energizes the compressor (not shown) to stop condensate build up in the drain pan 15. Simultaneously or a period of time thereafter, the logic panel 71 activates the pump 59 to the ON position or flushing mode. As explained above, the pump 59 creates a negative pressure or vacuum at the ICM inlet 51 and a positive pressure at the ICM outlet 53 thereby flushing the drainage system 17. The ICM 1 continues flushing the drainage system 17 for approximately one minute, or any other predetermined time period, to clean the drainage system 17 of zooglea, buildup, or other debris while the compressor of the air conditioning unit 3 is de-energized. After the ICM 1 flushes the drainage system 17 for approximately one minute, the logic panel 71 checks the float switch 91 to ascertain the condensate level in the drain pan 15.

If the float switch 91 indicates that the condensate level in the drain pan 15 is at a normal level, the logic panel 71 determines that the clog or obstruction in the drainage system 17 is cleared. Next, the logic panel 71 re-energizes the compressor to return the air conditioning unit 3 to normal operations and returns the ICM 1 to standby mode.

If the float switch 91 indicates that the condensate level in the drain pan 15 remains at an elevated level, the logic panel 71 determines that the clog or obstruction in the drainage system 17 is not cleared. According to an embodiment, the logic panel 71 may re-activate or energize the pump 59 to the ON position or flushing mode to attempt to clear the clog or obstruction in the drainage system. After each attempt the logic panel 71 may check the float switch 91 to determine the condensate level in the drain pan 15. If the float switch 91 indicates that the condensate level in the drain pan 15 is at a normal level after any subsequent attempt, the logic panel 71 determines that the clog or obstruction in the drainage system 17 is cleared. Next, the logic panel 71 reactivates the compressor to return the air conditioning unit 3 to normal operations and returns the ICM 1 to standby mode. However, after a predetermined number of attempts, or after only one attempt, to clear the clog or obstruction, the logic panel 71 may alert the user, homeowner, and/or monitoring company of the high condensate level in the drain pan 15. In order to prevent damage to the air conditioning unit 3, the logic panel 71 may keep the compressor de-energized. The logic panel 71 may additionally alert the user, homeowner, and/or monitoring company according to various alarm codes such as, for example, low battery, high condensate level, presence of water sensed by a water sensor (not shown), or a stuck float switch. According to an embodiment, the logic panel 91 may lock out the compressor from being re-energized.

According to an embodiment, the float switch 91 alerts the logic panel 71 of a high condensate level on a first motion of being elevated to a predetermined condensate level. Once the logic panel 71 is alerted of the high condensate level, the logic panel 71 operates as described above according to the sequence of FIG. 14, for example. By alerting the logic panel 71 on the first motion of being elevated to a predetermined condensate level, the float switch 91 avoids causing the compressor to jump start or short cycle on and off if, for example, the float switch bounces above and below the predetermined condensate level.

### Wiring Diagram and Alerts

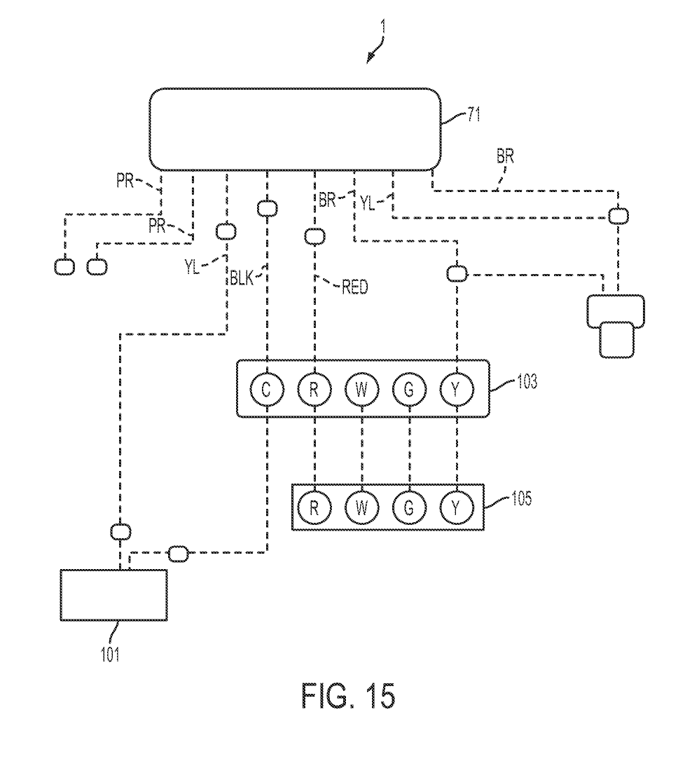

Referring now to FIG. 15, the ICM 1 may be wired from the logic board 71 to a user's or homeowner's heating, ventilation, and air conditioning system and alarm system. For example, the wires PR may be used on a security monitoring system, alarm system, or alternate device. The wires PR may form normally closed circuit or have continuity through the logic panel 71 under normal operating conditions of the air conditioning unit 3. However, if the logic panel 71 is alerted to an abnormal operating condition, such as a flooding or overflow condition, the circuit of wires PR opens thereby indicating the condition to the security monitoring system, alarm system, or alternate device.

The wire Y may be wired from the logic panel 71 to a compressor relay 101 to deliver 24-volt alternating current from the furnace 103 or air handler transformer (not shown) via wire BLK through the logic panel 71 to the compressor. Under normal operating conditions, the wire Y sends control current to operate the compressor. However, if the logic panel 71 is alerted to an abnormal operating condition, such as a flooding or overflow condition, the logic board 71 will lock out the control current to de-energize the compressor.

The wire B may be wired from the ICM logic panel 71 to the common terminal C of the furnace 103 or air handler 5. The wire B supplies the neutral or common side of the 24-volt alternating current circuit to the compressor relay 101. The wire B is also used to power the logic panel 71, charge the battery 77, and supply current to operate electronics within the logic panel 71.

The wire RED may be wired from the ICM logic panel 71 to the R terminal on the furnace 103 or air handler 5. The wire RED supplies the hot or low 24-volt alternating current supply from a transformer (not shown) within the furnace 103 or air handler 5. The wire RED completes the circuit with the wire B, described above, to power the logic panel 71, charge the battery 77, and supply current to operate electronics within the logic panel 71.

The wire W connects the furnace 101 or air handler 5 to thermostat 105 to call for heat at the furnace 101 or air handler 5.

The wire G connects the furnace 101 or air handler 5 to thermostat 105 to call for fan operation at the furnace 101 or air handler 5.

The wire Y connected to terminal Y of the furnace 101 or air handler 5 and terminal Y of thermostat 105 may be energized when the thermostat 105 closes the circuit within the thermostat 105 to call for air conditioning when temperature rises to above a predetermined level. The hot or low 24-volt alternating current flow via wire Y to a wire BR of the logic panel 71 and float switch 91. The wires BR and YL between the terminals Y of the thermostat 105 and furnace 103 or air handler 5 are normally closed under normal operating conditions. Therefore, under normal operating conditions when the float switch 91 is below a predetermined level, current flows through the float and other wire BR leaving the float switch 91. Current then flows into the wire YL and the wire BR to the logic panel 71. The wire YL passes current through the logic panel 71 and back to the wire YL to the compressor relay 101 to complete the control circuit. However, if the logic panel 71 is alerted to an abnormal operating condition, such as a flooding or overflow condition, the logic panel 71 will open the circuit to de-energize the compressor. Similarly, as the float switch 91 rises above a predetermined level, the float switch 91 will open the circuit to the logic panel 71 and break the 24-volt alternating current to the logic board 71. Additionally, the logic board 71 energizes the pump 59 to flush the drainage system 17, as described above.

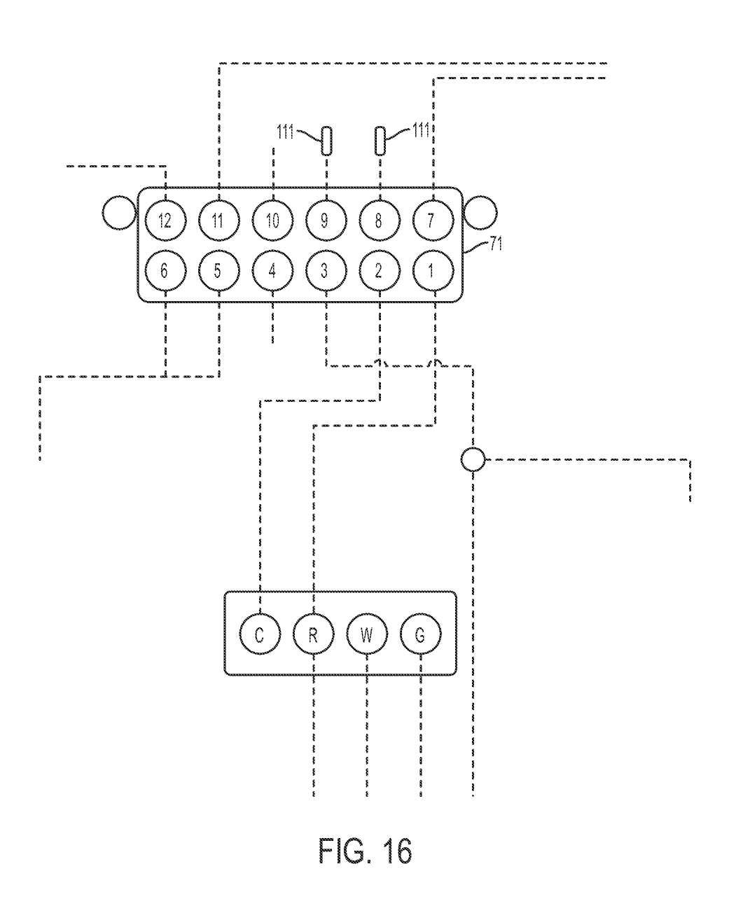

Referring now to FIG. 16, the logic board 71 of the ICM 1 may be additionally wired with a water sensor 111. According to an embodiment, the water sensor wires 111 are additionally connected to terminals 8 and 9, for example, of the logic board 71. Each water sensor wire 111 is placed apart from the other such that presence of a conductive fluid, such as condensate, will alert the logic board 71 of the presence of liquid.

### Flush Line Configuration

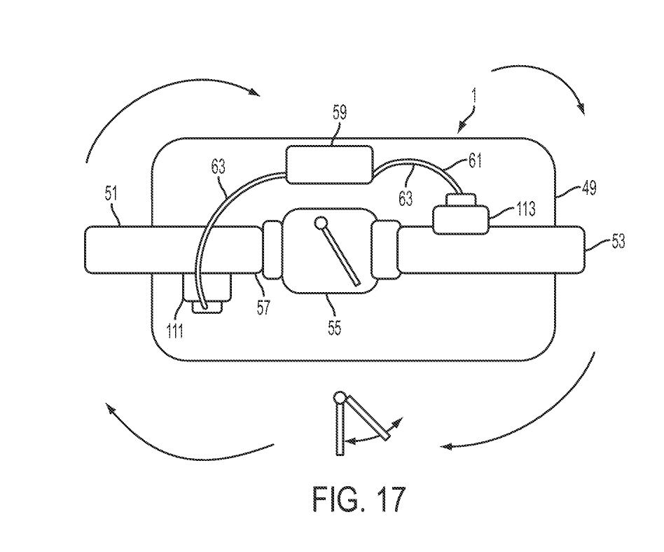

Referring now to FIG. 17, another embodiment of the ICM 1 is illustrated. Similar to FIG. 7, an embodiment of the ICM 1 is shown generally comprising the ICM housing 49 having the ICM inlet 51, the ICM outlet 53, the check valve 55 in the ICM primary condensate flow line 57, and the pump 59 in the ICM flush line 61. The ICM flush line 61 may connect to the upstream drainage portion 23 and/or the downstream drainage portion 25 while maintaining a parallel relationship with the ICM primary condensate flow line 57.

The pump inlet 111 to the ICM flush line 61 may be arranged at a lower portion of the ICM inlet 51 such that the pump inlet 111 is below a condensate or fluid level in the ICM inlet 51. According to an embodiment, the pump inlet 111 may be a port or a bull opening on a tee from the ICM inlet 51 in order to create a space under the ICM inlet 51 to collect a reservoir of condensate or fluid from the drainage system 17. According to an embodiment, the pump inlet 111 may be arranged at the lowermost portion of the ICM inlet 51. As condensate or fluid gravity drains away from the drain pan 15 and into the drainage system 17, a reservoir of condensate or fluid may be formed at the ICM inlet 51 and in the pump inlet 111 of the ICM flush line 61. According to an embodiment, the pump inlet 111 is always submerged in condensate or fluid when fluid is in the drainage system 17.

The pump outlet 113 of the ICM flush line 61 may be arranged at an upper portion of the ICM outlet 53. According to an embodiment, the pump outlet 113 may be arranged at the uppermost portion of the ICM outlet 53. According to an embodiment, the condensate or fluid level may be below the pump outlet 113 in order to reduce backpressure on or backflow to the pump 59.

When the pump 59 is activated, such as by an operating sequence, as explained above, the pump 59 may immediately draw in water from the pump inlet 111 submerged in condensate or fluid. The immediate draw of condensate or fluid may quickly and efficiently prime the pump and more quickly create a pressure differential to seal the check valve 55.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

I claim:

1. A condensate management system for purging and cleaning an air conditioning condensate drainage system, the condensate management system comprising:
a housing having a housing inlet and a housing outlet;
a primary condensate flow line from the housing inlet to the housing outlet having a check valve therein;
a flush line having a pump, wherein the flush line is fluidly connected from the housing inlet to the housing outlet;
a logic panel configured to actuate the pump between a standby mode and a flushing mode;
wherein the check valve is configured to allow fluid flow from the housing inlet to the housing outlet;
wherein when the logic panel actuates the pump to the flushing mode, the pump exerts a negative pressure at the housing inlet and a positive pressure at the housing outlet.

2. The condensate management system of claim 1, wherein the flush line is in parallel with the primary condensate flow line.

3. The condensate management system of claim 1, wherein the suction pressure at the housing inlet and the positive pressure at the housing outlet closes the check valve.

4. The condensate management system of claim 1, wherein the flush line further comprises a flush line check valve.

5. The condensate management system of claim 1, wherein the flush line further comprises a flush line inlet fluidly connected to the housing inlet and a flush line outlet fluidly connected to the housing outlet, wherein the flush line inlet fluidly connects to a lower portion of the housing inlet.

6. The condensate management system of claim 1, wherein the logic panel is further configured to detect an elevated condensate level in a drain pan of an air conditioner.

7. The condensate management system of claim 6, wherein the logic panel is further configured to de-energize a compressor of the air conditioner in order to prevent condensate overflow of the drain pan.

8. The condensate management system of claim 6, wherein the logic panel is further configured to actuate the pump to the flushing mode after the elevated condensate level in the drain pan is detected.

9. The condensate management system of claim 6, wherein the logic panel is further configured to actuate the pump to the standby mode and determine a condensate level in the drain pan after the pump is actuated to the standby mode.

10. The condensate management system of claim 1, wherein the logic panel is further configured to actuate the pump at predetermined time intervals for a predetermined time period.

11. A method for purging a condensate drainage system for an air conditioning system, wherein the air conditioning system comprises a compressor and a drain pan, the method comprising:
providing the condensate drainage system with a flush line having a pump fluidly connected to the condensate drainage system;
providing a check valve with the primary condensate flow line, wherein an inlet of the flush line is fluidly connected to the primary condensate flow line upstream of the check valve, and an outlet of the flush line is fluidly connected to the primary condensate flow line downstream of the check valve;
alerting a logic panel to a condition for flushing the condensate drainage system;
in response to the alerting the logic panel the condition for flushing, energizing the pump to pull fluid from the inlet of the flush line and discharge fluid to the outlet of the flush line, wherein the pressure differential caused by the pump causes the check valve to close;
de-energizing the pump; and
determining whether the condition for flushing the condensate drainage system is resolved.

12. The method of claim 1, further comprising connecting the inlet of the flush line to a lower portion of the primary condensate flow line.

13. The method of claim 1, further comprising flowing fluid through the flush line parallel with the primary condensate flow line.

14. The method of claim 1, wherein the condition for flushing comprises detecting an elevated condensate level in the drain pan.

15. The method of claim 1, wherein the condition for flushing comprises a predetermined time interval between flushings.

16. The method of claim 15, wherein energizing the pump further comprises energizing the pump for a predetermined time period.

17. The method of claim 16, wherein energizing the pump for the predetermined time period further comprises de-energizing and energizing the pump a predetermined number of times.

18. The method of claim 1, wherein the determining whether the condition for flushing the condensate drainage system is resolved further comprises detecting a fluid level in the drain pan after energizing the pump.

19. The method of claim 1, wherein the determining whether the condition for flushing the condensate drainage system is resolved further comprises detecting a fluid level in the drain pan after de-energizing the pump.

20. The method of claim 1, further comprising providing the flush line, the check valve, and the pump in a housing.
